(19) United States
(12) Patent Application Publication
(10) Pub. No.: US 2022/0383619 A1
(43) Pub. Date: Dec. 1, 2022

(54) METHOD FOR CLASSIFICATION OF CHILD SEXUAL ABUSIVE MATERIALS (CSAM) IN AN ANIMATED GRAPHICS

(71) Applicant: Antitoxin Technologies Inc., Palo Alto, CA (US)

(72) Inventors: Ron PORAT, Tel-Mond (IL); Dorit ZIBERBRAND, Ramat Gan (IL); Eitan BROWN, Petach Tikva (IL); Hezi STERN, Even-Yehuda (IL); Yaakov SCHWARTZMAN, Petach Tikva (IL); Avner SAKAL, Ramat HaSharon (IL)

(73) Assignee: Antitoxin Technologies Inc., Palo Alto, CA (US)

(21) Appl. No.: 17/825,183

(22) Filed: May 26, 2022

Related U.S. Application Data
(60) Provisional application No. 63/219,432, filed on Jul. 8, 2021.
(60) Provisional application No. 63/193,178, filed on May 26, 2021.

(51) Int. Cl. G06V 10/764; G06V 40/16; G06V 10/774; G06V 10/762

(52) U.S. Cl. CPC G06V 10/764; G06V 40/162; G06V 10/774; G06V 40/178; G06V 10/762

(57) ABSTRACT

There is provided a method of training a machine learning model, comprising: extracting faces from first images, creating an age training dataset comprising records each including a face and a ground truth label indicating whether the face is below a legal age, training an age component on the age training dataset for generating a first outcome indicative of a target face of the target image being below the legal age, creating a sexuality training dataset comprising second records each including a second image and ground truth label indicative of sexuality, training a sexuality component on the sexuality training dataset for generating a second outcome indicative of sexuality depicted in the target image, defining a combination component that receives an input of a combination of the first outcome and the second outcome, and generates a third outcome indicative of child sexual abusive materials (CSAM) depicted in the target image.

### RELATED APPLICATIONS

This application claims the benefit of priority of U.S. Provisional Patent Application Nos. 63/219,432 filed on Jul. 8, 2021 and 63/193,178 filed on May 26, 2021, the contents of which are incorporated by reference as if fully set forth herein in their entirety.

### FIELD AND BACKGROUND OF THE INVENTION

The present invention, in some embodiments thereof, relates to machine learning models for image classification and, more specifically, but not exclusively, to system and methods for using machine learning models for classification of CSAM in images.

Child sexual abuse material is a type of pornography that exploits children. Making, possessing, and distributing CSAM materials is illegal and subject to prosecution in most jurisdictions around the world.

### SUMMARY OF THE INVENTION

According to a first aspect, a method of training a machine learning model for detection of child sexual abusive materials (CSAM) depicted in a target image, comprises: extracting segmentations of faces depicted in a plurality of first images of a plurality of first individuals in a plurality of first poses, creating an age training dataset comprising a plurality of first records, wherein a first record includes an extracted segmented face and a ground truth label indicating whether the face is of an individual below a legal age, training an age component on the age training dataset for generating a first outcome indicative of a target face segmented from the target image of a target individual being below the legal age, creating a sexuality training dataset comprising a plurality of second records, wherein a second record includes a second image and ground truth label indicative of sexuality depicted in the second image, training a sexuality component on the sexuality training dataset for generating a second outcome indicative of sexuality depicted in the target image, defining a combination component that receives an input of a combination of the first outcome of the age component fed the target image and the second outcome of the sexuality component fed the target image, and generates a third outcome indicative of CSAM depicted in the target image, and providing the machine learning model comprising the age component, the sexuality component, and the combination component.

According to a second aspect, a method of automated detection of CSAM depicted in a target image, comprises: feeding a segmentation of a target face extracted from a target image, into an age component of a machine learning model, wherein the age component is trained on an age training dataset comprising a plurality of first records, wherein a first record includes a face extracted from an image of an individual in a certain pose and a ground truth label indicating whether the face is of an individual below a legal age, obtaining from the age component, a first outcome indicative of a target individual associated with the target face being below the legal age, feeding the target image into a sexuality component of a machine learning model, wherein the sexuality component is trained on a sexuality training dataset comprising a plurality of second records, wherein a second record includes a second image and ground truth label indicative of sexuality depicted in the second image, obtaining from the sexuality component, a second outcome indicative of sexuality depicted in the target image, feeding the first outcome and the second outcome into a combination component of the machine learning model, and obtaining a third outcome indicative of CSAM depicted in the target image.

According to a third aspect, a system for automated detection of CSAM depicted in a target image, comprises: at least one hardware processor executing a code for: feeding a segmentation of a target face extracted from a target image, into an age component of a machine learning model, wherein the age component is trained on an age training dataset comprising a plurality of first records, wherein a first record includes a face extracted from an image of an individual in a certain pose and a ground truth label indicating whether the face is of an individual below a legal age, obtaining from the age component, a first outcome indicative of a target individual associated with the target face being below the legal age, feeding the target image into a sexuality component of a machine learning model, wherein the sexuality component is trained on a sexuality training dataset comprising a plurality of second records, wherein a second record includes a second image and ground truth label indicative of sexuality depicted in the second image, obtaining from the sexuality component, a second outcome indicative of sexuality depicted in the target image, feeding the first outcome and the second outcome into a combination component of the machine learning model, and obtaining a third outcome indicative of CSAM depicted in the target image.

In a further implementation form of the first, second, and third aspects, the age training dataset excludes images depicting CSAM.

In a further implementation form of the first, second, and third aspects, the sexuality training dataset excludes images depicting individuals below the legal age.

In a further implementation form of the first, second, and third aspects, further comprising creating a combination training dataset comprising a plurality of third records, wherein a third record includes the first outcome of the age component fed a sample image and the second outcome of the sexuality component fed the sample image, and a ground truth label indicative of CSAM depicted in the sample image.

In a further implementation form of the first, second, and third aspects, the combination component comprises a set of rules that generates the third outcome indicating presence of CSAM in the target image when the first outcome of the age component indicates the target individual below the legal age and the second outcome of the sexuality component indicates sexuality depicted in the target image.

In a further implementation form of the first, second, and third aspects, the ground truth label indicative of sexuality depicted in the second image of the record of the sexuality training dataset indicates a clean image that excludes sexuality, or indicates a sexuality category selected from a plurality of sexuality categories indicative of increasing severity, wherein the second outcome comprises the indication of the clean image, or the sexuality category.

In a further implementation form of the first, second, and third aspects, the combination component generates the third outcome indicative of CSAM depicted in the target image when the first outcome indicates under legal age and the second outcome indicates any of the plurality of sexuality categories.

In a further implementation form of the first, second, and third aspects, the ground truth label indicating whether the face is of an individual below the legal age of the record of the age training dataset comprises at least one of: legal age, actual age, and an age category selected from a plurality of age categories under legal age, wherein the first outcome comprises the indication of the legal age, the actual age, or the age category under legal age.

In a further implementation form of the first, second, and third aspects, the combination component generates the third outcome indicative of CSAM depicted in the target image when the first outcome is an age under the legal limit or any of the age categories indicating under the legal limit.

In a further implementation form of the first, second, and third aspects, further comprising at least one of: (i) blurring a segmentation of the target individual in the target image, (ii) blocking presentation of the target image on a display, (iii) deleting the target image from a data storage device, (iv) when the target image is a frame in an animation for which the other frames are not identified as CSAM, removing the frame from the animation to create a non-CSAM animation, and (v) sending a notification to a server.

In a further implementation form of the first, second, and third aspects, the target image comprises an animation created from a plurality of frames, further comprising sampling at least one sample frame from the plurality of frames as at least one specific target image, wherein the features of the method are iterated for each specific target image, wherein CSAM is identified for the animation when the third outcome indicative of CSAM is depicted in a number of sample frames is above a threshold.

In a further implementation form of the first, second, and third aspects, further comprising: identifying a plurality of clusters of frames for which CSAM is identified, classifying each cluster into a category of a CSAM scale of increasing CSAM severity.

In a further implementation form of the first, second, and third aspects, further comprising: for each cluster, creating a data structure that includes at least one of: confidence of CSAM identification, start time of the animation when CSAM is identified, stop time of the animation when CSAM is identified, and most severe category of the CSAM scale detected.

In a further implementation form of the first, second, and third aspects, further comprising: in response to the third outcome being indicative of CSAM, computing a hash of the target image and storing the hash in a hash dataset, wherein in response to a new image, computing the hash of the new image, and searching the hash dataset to identify a match with the hash of the new image.

In a further implementation form of the first, second, and third aspects, further comprising segmenting each of a plurality of target faces depicted in the target image, and feeding each of the plurality of target faces into the age component to obtain a plurality of first outcomes, wherein the combination component generates the third outcome indicative of CSAM when at least one of the plurality of target faces is identified as under legal age.

In a further implementation form of the third aspect, further comprising code for training the machine learning model for detection of child sexual abusive materials (CSAM) depicted in a target image, comprising: extracting segmentations of faces depicted in a plurality of first images of a plurality of first individuals in a plurality of first poses, creating the age training dataset comprising a plurality of first records, wherein a first record includes an extracted segmented face and a ground truth label indicating whether the face is of an individual below a legal age, training the age component on the age training dataset for generating a first outcome indicative of a target face segmented from the target image of a target individual being below the legal age, creating the sexuality training dataset comprising a plurality of second records, wherein a second record includes a second image and ground truth label indicative of sexuality depicted in the second image, training the sexuality component on the sexuality training dataset for generating a second outcome indicative of sexuality depicted in the target image, defining the combination component that receives an input of a combination of the first outcome of the age component fed the target image and the second outcome of the sexuality component fed the target image, and generates a third outcome indicative of CSAM depicted in the target image, and providing the machine learning model comprising the age component, the sexuality component, and the combination component.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for training a machine learning model for detection of CSAM depicted in a target image (i.e., CSAM ML model), and/or for inference of the target image by the ML model for detection of CSAM depicted therein, in accordance with some embodiments of the present invention;

FIG. 2 is a flowchart of a method of training the CSAM machine learning model for detection of CSAM depicted in a target image, in accordance with some embodiments of the present invention;

FIG. 3 is a flowchart of a method of inference of the target image by the CSAM ML model for detection of CSAM depicted therein, in accordance with some embodiments of the present invention;

FIG. 4 is a data flow diagram depicting different exemplary flows for evaluating an image for CSAM, in accordance with some embodiments of the present invention; and

FIG. 5 is a data flow diagram depicting different exemplary flows for evaluating an image identified as depicting CSAM therein, in accordance with some embodiments of the present invention.

### DESCRIPTION OF SPECIFIC EMBODIMENTS OF THE INVENTION

The present invention, in some embodiments thereof, relates to machine learning models for image classification and, more specifically, but not exclusively, to system and methods for using machine learning models for classification of CSAM in images.

As used herein, the term image and animation may sometimes be interchanged. For example, an image being evaluated for CSAM may be an animation that includes multiple frames.

An aspect of some embodiments of the present invention relates to systems, methods, an apparatus (e.g., computing device), and/or code instructions (e.g., stored on a memory and executable by hardware processor(s)) for training a machine learning model (ML) for detection of child sexual abusive materials (CSAM) depicted in a target image, also referred to herein as a CSAM ML model. The CSAM ML model includes an age component (also referred to herein as an age ML model), a sexuality component (also referred to herein as a sexuality ML model), and a combination component. One or more faces (e.g., segmentations thereof) depicted in multiple sample images of different individuals in different poses are extracted. Each face is associated with a ground truth label indicating whether the face is of an individual below a legal age (i.e., legal age for appearing in sexuality explicit images, for example, 18 or 21 years old). An age training dataset of multipole records is created, where each record includes a respective segmented face and the corresponding ground truth label. The age component is trained on the age training dataset. The age component generates a first outcome indicative of whether a target face is below the legal age, in response to an input of the target face that may be segmented from a target image. A sexuality training dataset of multiple records is created. Each record of the sexuality training dataset include an image and a ground truth label indicative of sexuality depicted in the image. None of the images used in the training dataset are CSAM images depict sexuality of underage children. For the age training dataset, none of the images of children under the legal age depict sexuality. For the sexuality training dataset, none of the images depicting sexuality are of children under age. At least some images used for the age training dataset and for the sexuality training dataset are unique only to those training dataset, since images used for sexuality cannot depict children and images depicting children cannot depict sexuality. A sexuality component is trained on the sexuality training dataset. The sexuality component generates a second outcome indicative of sexuality depicted in a target image in response to an input of the target image. A combination component is defined, for example, as a set of rules and/or ML model. The combination component receives an input of a combination of the first outcome of the age component fed the target image and the second outcome of the sexuality component fed the target image, and generates a third outcome indicative of CSAM depicted in the target image.

An aspect of some embodiments of the present invention relates to systems, methods, an apparatus (e.g., computing device), and/or code instructions (e.g., stored on a memory and executable by hardware processor(s)) for detection of CSAM depicted in a target image using a CSAM ML model. A target image is accessed. One or more target faces are identified in the target image, and each target face may be segmented. Each target face (e.g., extracted segmentation) is fed into the age component of the CSAM machine learning model. A first outcome indicative of a whether the inputted target face depicts an individual being below the legal age is obtained from the age component. The target image is fed into a sexuality component. A second outcome indicative of sexuality depicted in the target image is obtained from the sexuality component. A combination of the first outcome and the second outcome is fed into the combination component of the machine learning model. A third outcome indicative of CSAM depicted in the target image is obtained from the combination component.

At least some implementations described herein address the technical problem of training a machine learning model for detection of CSAM. At least some implementations described herein improve the technical field of machine learning models, by providing an approach for training a machine learning model for detection of CSAM in an image. A machine learning model cannot be trained to detect CSAM using standard supervised approaches. For example, by obtaining CSAM and non-CSAM images, labelling the images according with ground truth labels indicating CSAM and non-CSAM, and training the ML model on the labelled CSAM and non-CSAM images. Such standard approaches cannot practically be used, since CSAM images are illegal to possess, distribute, and/or create, and therefore, CSAM images cannot be used in training. At least some implementations described herein provide a technical solution to the technical problem, and/or improve the technical field of machine learning, by using three components of the CSAM ML model, an age component, a sexuality component, and a combination component. The age component is trained to generate an outcome indicative of whether a face (e.g., extracted from an image) represents an individual that is under age. The age component is trained on images depicting faces of individuals of varying ages, labelled with an indication of individuals that are under legal age. Images depict individuals below legal age and above legal age. No images depicting sexuality of children below the legal age are included (as used herein, the term children may refer to individuals below the legal age). The sexuality component is trained to generate an outcome indicative of whether an input image is “clean”, i.e., does not depict any sexuality, or depicts sexuality. The sexuality component is trained on images labelled with an indication of whether the image depicts sexuality (e.g., of varying levels) or is a clean image. All images depicting sexuality are of individuals over the legal age limit, i.e., adults. No images depicting sexuality are of children. The combination component receives an input of the outcomes of the age component and the sexuality component, and generates an indication of CSAM when at least one face in the image of an individual under the legal age and when sexuality is depicted (e.g., any degree of sexuality and/or when the image is non-clean).

At least some implementations described herein address the technical problem of automatically identifying CSAM images, for example, being transferred between users over a network and/or downloaded by a user from a server. CSAM images are illegal in many jurisdictions. Identification of CSAM is traditionally manually performed by a human, such as a user, administrator of a network (e.g., social network), and/or a professional (e.g., police officer, social worker, and the like). Such manual identification is slow and/or non-encompassing, since many CSAM images are kept hidden by passing them between selected users to avoid being caught. Moreover, the large number of images stored on network servers and/or exchanged between network users is so large, that it is impossible to manually evaluate images for CSAM. CSAM images are automatically detected by the CSAM ML model described herein, enabling real time detection, and which may enable, for example, real time alert of the police to catch the offenders, and/or real time blocking of the images to prevent viewing and/or distribution.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

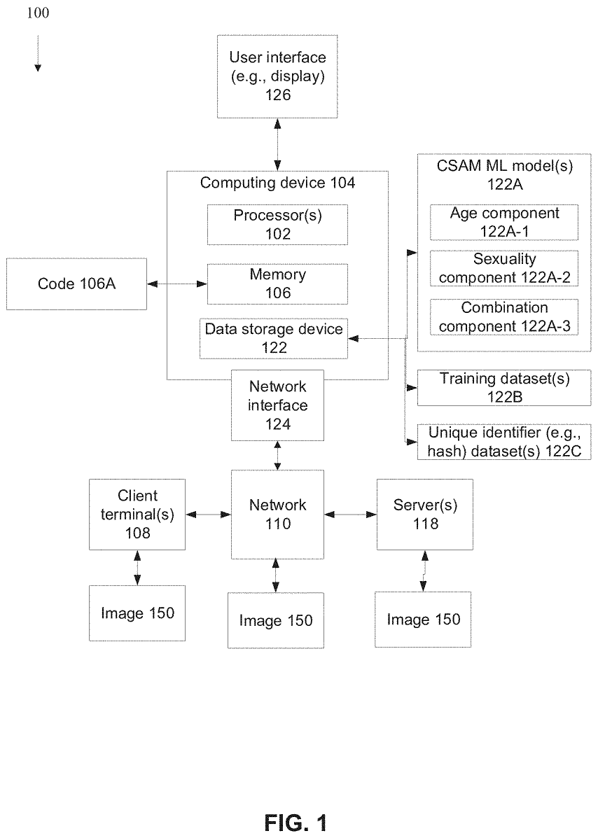

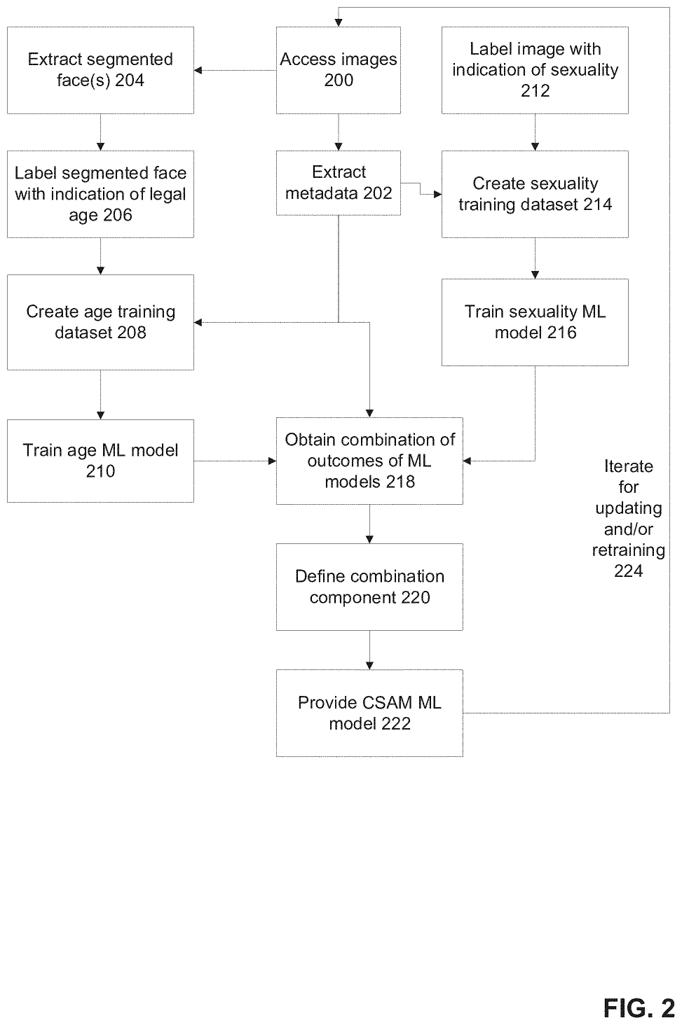

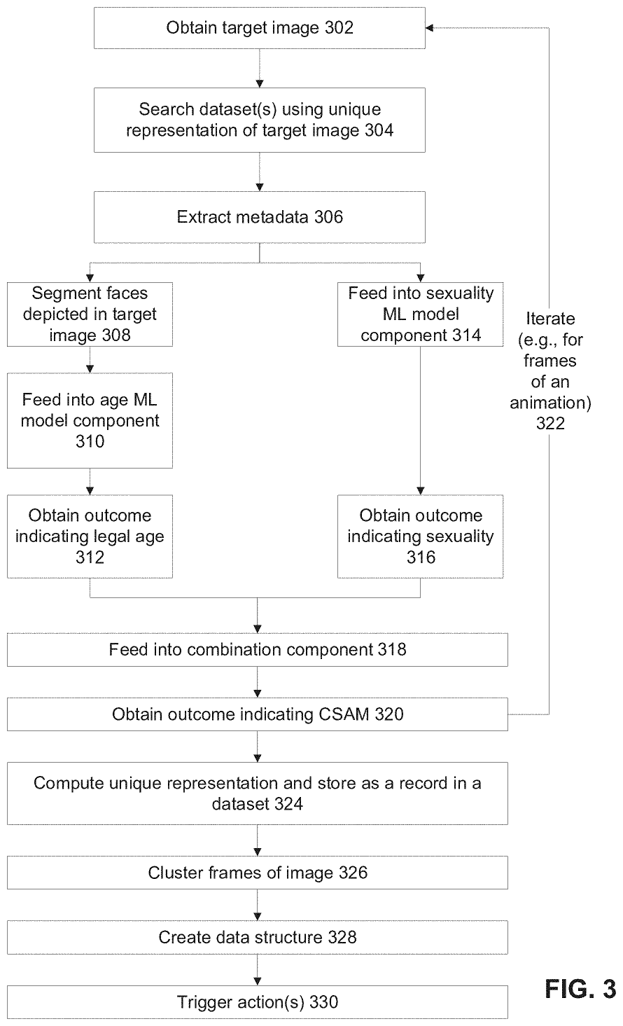

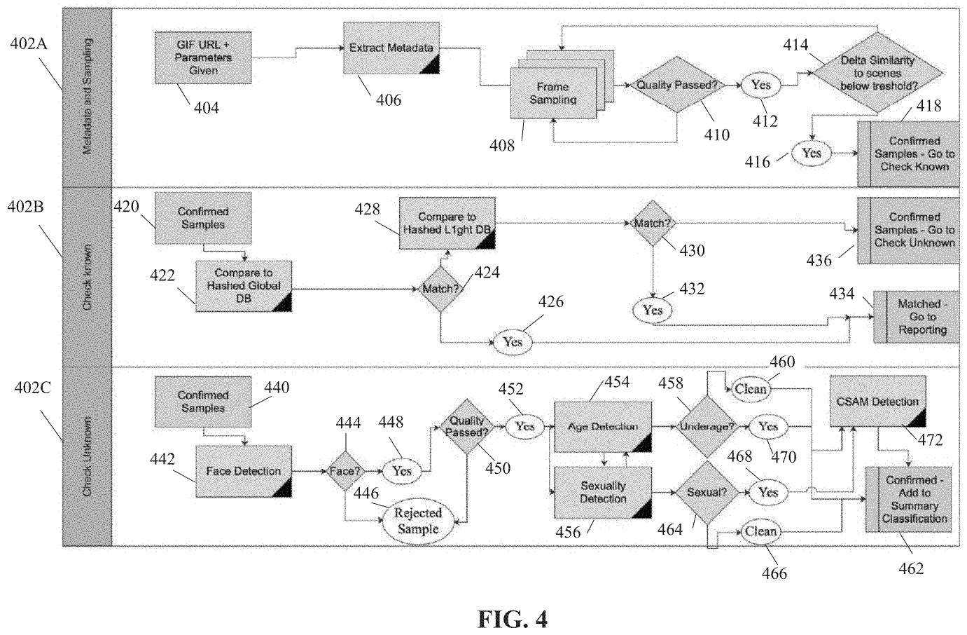

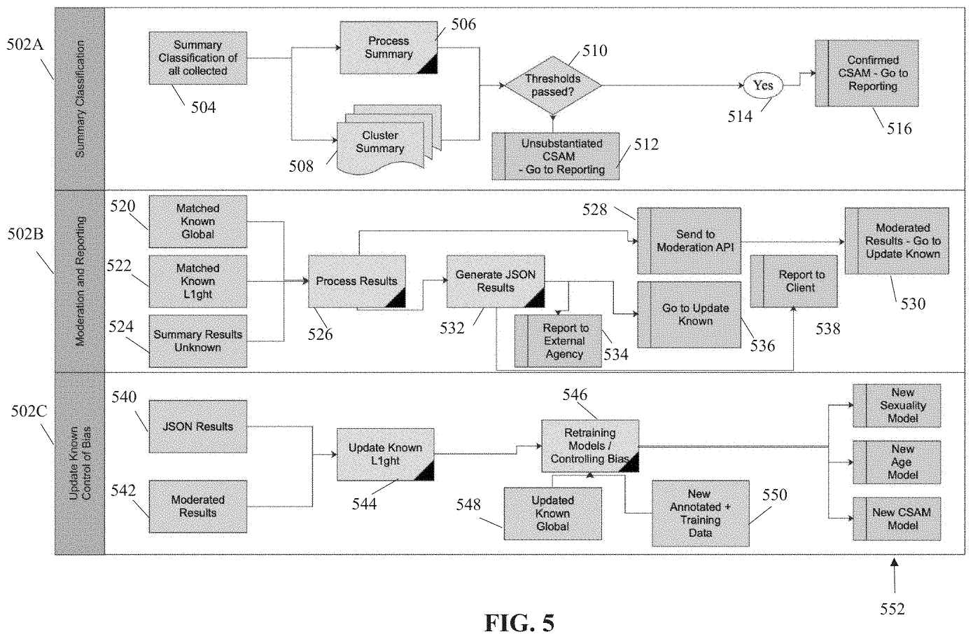

Reference is now made to FIG. 1, which is a block diagram of components of a system 100 for training a machine learning model for detection of CSAM depicted in a target image (i.e., CSAM ML model), and/or for inference of the target image by the ML model for detection of CSAM depicted therein, in accordance with some embodiments of the present invention. Reference is also made to FIG. 2, which is a flowchart of a method of training the CSAM machine learning model for detection of CSAM depicted in a target image, in accordance with some embodiments of the present invention. Reference is also made to FIG. 3, which is a flowchart of a method of inference of the target image by the CSAM ML model for detection of CSAM depicted therein, in accordance with some embodiments of the present invention. Reference is also made to FIG. 4, which is a data flow diagram depicting different exemplary flows 402A-C for evaluating an image for CSAM, in accordance with some embodiments of the present invention. Reference is also made to FIG. 5, which is a data flow diagram depicting different exemplary flows 502A-C for evaluating an image identified as depicting CSAM therein, in accordance with some embodiments of the present invention.

System 100 may implement the acts of the method described with reference to FIGS. 2-5, by processor(s) 102 of a computing device 104 executing code instructions stored in a memory 106 (also referred to as a program store).

Computing device 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Multiple architectures of system 100 based on computing device 104 may be implemented. For example:
Computing device 104 may be implemented as a standalone device (e.g., kiosk, client terminal, smartphone) that include locally stored code instructions 106A that implement one or more of the acts described with reference to FIGS. 2-5. The locally stored code instructions 106A may be obtained from another server, for example, by downloading the code over the network, and/or loading the code from a portable storage device. An image 150 being evaluated for CSAM may be obtained, for example, by a user manually entering a path where image 150 is stored, intercepting image 150 being transferred by user(s) across a network, and/or a user activating an application that automatically analyzes images 150 stored on computing device 104 and/or accessed by computing device 104 (e.g., over a network 110, and/or stored on a data storage device 122). The computing device may locally analyze image 150 using code 106A and/or by feeding image 150 into CSAM ML model(s) 122A. The outcome, such as indication of whether image 150 depicts CSAM and/or category of CSAM, may be presented on a display (e.g., user interface 126). Other actions may be taken when CSAM is detected, for example, sending a notification to authorities (e.g., server(s) 118), blocking transfer of image 150 over network 110, deleting image 150 from data storage device 122, and/or filtering out the CSAM parts to generate a non-CSAM adapted image.
Computing device 104 executing stored code instructions 106A, may be implemented as one or more servers (e.g., network server, web server, a computing cloud, and a virtual server) that provides centralized services (e.g., one or more of the acts described with reference to FIGS. 2-5). Services may be provided, for example, to one or more client terminals 108 over network 110, to one or more server(s) 118 over network 110, and/or by monitoring traffic over network 110. Traffic over network 110 may be monitored, for example, by a sniffing application that sniffs packets, and/or by an intercepting application that intercepts packets. Server(s) 118 may include, for example, social network servers that enable transfer of files including images between users, and/or data storage servers that store data including files, which are accessed and/or downloaded by client terminals. Services may be provided to client terminals 108 and/or server(s) 118, for example, as software as a service (SaaS) t, a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web sited hosted by computing device 104. For example, image(s) 150 are provided from each respective client terminal 108 and/or server(s) 118 to computing device 104. In another example, image(s) 150 are obtained from network 110, such as by intercepting and/or sniffing packets to extract images from packet traffic running over network 110. Computing device centrally feeds images 150 into the CSAM machine learning model 122A, and provides the outcomes (e.g., indicating presence of CSAM, CSAM category, lack of CSAM, adapted images that exclude CSAM, and the like), for example, for presentation on a display of each respective client terminal 108 and/or server(s) 118, for notifying authorities, for removal of CSAM images, and the like, as described herein.

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-5 when executed by hardware processor(s) 102.

Computing device 104 may include a data storage device 122 for storing data, for example, the CSAM machine learning model(s) 122A, training dataset(s) 122B for training ML model(s) 122A, and/or datasets storing records of unique identifiers (e.g., hash) computed for previously evaluated images (e.g., enabling fast look-up of new images to determine if the same images has been previously determined to be CSAM and/or non-CSAM). CSAM ML model 122A includes age component 122A-1, sexuality component 122A-2, and/or combination component 122A-3, as described herein. Data storage device 114 may be implemented as, for example, a memory, a local hard-drive, virtual storage, a removable storage unit, an optical disk, a storage device, and/or as a remote server and/or computing cloud (e.g., accessed using a network connection).

Exemplary architectures of the machine learning models described herein include, for example, statistical classifiers and/or other statistical models, neural networks of various architectures (e.g., convolutional, fully connected, deep, encoder-decoder, recurrent, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised and/or reinforcement learning.

Network 110 may be implemented as, for example, the internet, a local area network, a virtual network, a wireless network, a cellular network, a local bus, a point to point link (e.g., wired), and/or combinations of the aforementioned.

Computing device 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 and/or client terminal(s) 108 include and/or are in communication with one or more physical user interfaces 126 that include a mechanism for a user to enter data (e.g., manually designate the location of image 150 for analysis of CSAM) and/or view the displayed results (e.g., indication of detected CSAM and/or category of CSAM), within a GUI. Exemplary user interfaces 126 include, for example, one or more of, a touchscreen, a display, gesture activation devices, a keyboard, a mouse, and voice activated software using speakers and microphone.

Referring now back to FIG. 2, at 200, multiple images are accessed. Image files may include single images, or a sequence of images arranged as an animation.

As discussed herein, sexual images of children under the legal age are illegal to possess, distribute, and/or generate. As such, traditional approaches of taking such images and labelling them with a tag indicating CSAM cannot be used, since such CSAM images cannot be legally obtained and/or cannot be legally used to train a traditional ML model.

Two types of images are available. A first type of images is “clean”, and excludes any sexual imagery, such as nudity and/or sexual acts. Such “clean” first images may depict underage children. A second type of image is “non-clean”, and depicts sexual imagery, such as nudity and/or sexual acts. Such sexual second images exclude underage children, and only include adults over a legal age.

Examples of formats of images include GIF, and Webp.

At 202, metadata may be extracted from the images. Metadata may indicate specific properties of the image. Metadata may increase accuracy of the ML model components, by being included in the training dataset and/or fed into the ML model components during inference. Examples of metadata include amount of lighting (e.g., dark, light), amateur or professional, time of day (e.g., night or day), background identification (e.g., indoors, outdoors), and location identification (e.g., electrical, wording, geolocation on video).

Features 204-210 relate to creating the age component (i.e., age ML model) of the CSAM ML model, features 212-216 relate to creating the sexuality component (i.e., sexuality ML model) of the CSAM ML model, and features 218-230 relate to creating the combination component (i.e., combination ML model) of the CSAM ML model.

At 204, segmentations of faces depicted in the first “clean” images of individuals of different ages, including under the legal age, are extracted. The individuals may be in different poses, performing different actions and/or facing in different directions. For example, individuals may be looking up, down, and/or to a side, and not necessarily but may be facing forwards. Faces that are identified may be extracted.

There may be multiple faces simultaneously depicted in a same image. The multiple different faces may be segmented and removed.

Segmentation may be performed, for example, by a face segmentation ML model (e.g., neural network) trained to identify and segment faces, for example, trained on a training dataset of images labelled with ground truth segmentations (e.g., boundaries manually marked by users). Other segmentation approaches may be used.

Segmentation may be performed to obtain a single face per segmentation. Segmentation may include, for example, dividing the image into sub-portions, where a respective single face is depicted per sub portion.

Alternatively, faces are not segmented, but rather the image as a whole is used, such as when a single face is depicted per image.

At 206, a ground truth label is created for the respective segmented face. The label indicates at least whether the respective segmented face is of an individual below a legal age. In an example, the label include a binary classification indicating whether the face is of an individual below the legal age or not. In another example, the label includes an age category selected from multiple age categories, which include one or more categories under legal age, for example, Baby, Child, Teen, Older Teen, and Adult. In yet another example, first a label indicates whether the face is of a person below the legal age, or above the legal age. For people below the legal age, a classification of teen, child, or baby (e.g., using configurable age ranges and/or manually set) may be used. In yet another example, the label indicates an actual numerical age of the individual whose face is depicted, for example, 5, 10, 12, 16, 18, 20, and 30.

At 208, an age training dataset of multiple records is created. Each record includes a respective extracted segmented face and the corresponding ground truth label. Optionally, each record includes one or more metadata items extracted from the respective image.

The age training dataset excludes images depicting CSAM, i.e., all images depicting children under the legal age are “clean” without any nudity and/or sexuality.

At 210, an age component of the CSAM ML model, i.e., an age ML model, is trained on the age training dataset. The age ML model generates an outcome indicative of a target face segmented from a target image of a target individual being below the legal age (or other classification category when below the legal age and/or the numerical age, according to the labels of the age training dataset), in response to an input of the segmented target face and/or the target image.

At 212, ground truth label are created for the second type of sexuality images. The ground truth labels indicate sexuality depicted in the respective image of the second type.

The label indicates at least whether the respective second type of image depicts sexuality or not. In an example, the label include a binary classification indicating whether the respective image depicts sexuality or not (i.e., “clean” image that excludes sexuality). In another example, the label includes a sexuality category selected from multiple sexuality categories, which may indicate increasing severity of the depicted sexuality. Examples of sexuality categories include:
SEXUAL_ACTIVITY—A frame depicts sexual activity (e.g., single and/or multiple participants).
NUDITY—A frame depicts nudity (e.g., single or multiple participants) but no apparent sexual activity. Nudity implies the inclusion of sexual organs, buttocks or female breasts.
ART_SEXUAL—A frame depicts nudity and/or sexual activity of an artificial (e.g., cartoon, hentai, or CGI) source (e.g., single or multiple participants).
EROTICA—A frame depicts sexual-implied theme and/or erotic-implied theme without the exposed clear sexual organs, buttocks and/or female breasts (e.g., single and/or multiple participants).
CLEAN—No toxic content is depicted within the frame.

At 214, a sexuality training dataset of multiple records is created. Each record includes a respective second type of image and corresponding ground truth label indicative of sexuality. Optionally, each record includes one or more metadata items extracted from the respective image.

Images having corresponding ground truth labels indicating sexuality being depicted (i.e., non-clean images) exclude individuals below the legal age. In other words, all images for which the corresponding ground truth labels indicate sexuality all depict adults over the legal age.

At 216, a sexuality component of the CSAM ML model, i.e., a sexuality ML model, is trained on the sexuality training dataset. The sexuality ML model generates an outcome indicative of sexuality (e.g., clean or non-clean, and/or sexuality category) depicted in a target image in response to an input of the target image.

At 218, a combination of a first outcome of the age ML model fed a sample image, and a second outcome of the sexuality component fed the same sample image, is accessed. The combination may include one or more metadata items extracted from the sample image.

At 220, a combination component of the CSAM ML model is defined and/or trained and/or created. The combination component generates a third outcome indicative of CSAM depicted in a target image in response to receiving an input that includes a combination of the first outcome of the age ML model fed the target image and the second outcome of the sexuality component fed the same target image.

The third outcome indicative of CSAM indicates at least whether the target image depicts CSAM. In an example, third outcome includes a binary classification indicating whether the target image face depicts CSAM or not. In another example, the third outcome includes a CSAM category selected from multiple CSAM categories, which may be of increasing severity, for example, according to a define CSAM scale, for example, the Oliver scale, and the Copine scale. In yet another example, the third outcome indicates a numerical value indicative of severity of CSAM on a defined scale.

The combination component may be implemented as a set of rules. The set of rules may indicate that CSAM is depicted in the target image when the first outcome of the age component indicates that a target individual depicted in the target image is below the legal age (i.e., any age category below the legal age, and/or any numerical age below the legal age) and the second outcome of the sexuality component indicates sexuality depicted in the target image (i.e. any sexuality category). In another example, the set of rules may map the combination of the first outcome and second outcome to one of the CSAM categories on a CSAM scale. For example, different sexuality categories are mapped to corresponding CSAM categories.

Alternatively or additionally, the combination component may be implemented as a combination ML model. A combination training dataset of multiple records may be created. Each record includes the first outcome of the age component fed a sample image and the second outcome of the sexuality component fed the same sample image. Each record is labelled with a ground truth label indicative of CSAM depicted in the sample image. However, since no CSAM images can actually be used in the training process, the images may be labelled with a label indicating that no CSAM is depicted in the sample images. The combination ML model may be updated, for example, during real time inference, when CSAM images are detected by the set of rules, and the CSAM image which was processed is retroactively assigned a ground label indicating that the input image depicts CSAM, for updating the training of the combination ML model. In this manner, no CSAM images are stored and/or used for training, but when such CSAM images are detected in real time, the combination ML model may be updated to help identify future CSAM images.

In some implementations, the combination component is initially implemented as a set of rules. The evaluation of images by the CSAM ML model and set of rules implementation of the combination components, which designates the images as CSAM or non-CSAM, may be used to dynamically train the ML model implementation of the combination component. Once enough images have been evaluated to obtain a target performance of the combination ML model, the combination ML model may be used instead of the set of rules. Since images dynamically received for evaluation, for which CSAM is initially unknown, as dynamically used to train the ML model, no CSAM images are stored for training the combination ML model, thereby satisfying legal requirements.

At 222, the CSAM machine learning model is provided. The CSAM ML model includes the age component, the sexuality component, and the combination component.

At 224, one or more features described with reference to 200-222 may be iterated. The iterations may be performed for updating and/or retraining the CSAM ML model and/or components thereof, using newly received images which were identified as CSAM and/or identified as non-CSAM by the CSAM ML model and/or manually labelled by a user upon visual inspection (e.g., when the CSAM ML model did not accurately automatically determine CSAM)

Referring now back to FIG. 3, At 302, a target image is obtained. The target image may be obtained, for example, by being intercepted during transmission over a network, by a filtering application that analyzes content items being posted to a social network, and/or obtained from a storage device (e.g., stored on a server).

At 304, a unique representation, such as a non-visual representation, of the target image may be computed, for example, a hash may be computed using a hashing process. The unique representation enables uniquely identifying the image without actually storing a visual representation of the images, which may be prohibited when the images is CSAM. The hash enables identifying CSAM images without actually storing visual representation of the CSAM, which is illegal. A hash (or other non-visual unique representation) dataset of stored non-visual unique representation (e.g., hashes) of previously identified CSAM images may be searched to find a match with the hash of the target image. A match indicates that the target image is CSAM. In such a case, one or more actions described with reference to 328 of FIG. 3 may be implemented. When no match is found, the target image is analyzed to determine whether CSAM is depicted therein, by proceeding to feature 306.

At 306, metadata may be extracted from the target image. Examples of metadata are described with reference to 202 of FIG. 2.

At 308, faces depicted in the target image may be segmented, for example, by feeding the target image into the segmentation ML model described herein, and/or using other approaches. When there are multiple faces depicted in the same target each, each of the faces is segmented into its own segmentation depicting a single face. Alternatively, when the target image depicts a single face, the image is not necessarily segmented.

At 310, the one or more segmentations of respective target faces extracted from the target image are fed into the age component of the CSAM machine learning model. Optionally, the metadata extracted from the target image is fed into the age component in combination with the segmentations of the target face(s) extracted from the target image.

At 312, a first outcome indicative of whether the respective target face represents a respective target individual below the legal age limit is generated by the age component for the input of segmented target face(s) extracted from the target image. When multiple segmented target faces are extracted from the target image, a respective outcome is obtained for each segmented face.

At 314, the target image is fed into the sexuality component of the CSAM machine learning model. Optionally, the metadata extracted from the target image is fed into the sexuality component in combination with the target image.

The target image may be fed into the sexuality component in parallel with being fed into the age component, and/or sequentially, before and/or after being fed into the age component.

At 316, a second outcome indicative of sexuality depicted in the target image is obtained from the sexuality component.

At 318, the first outcome and the second outcome obtained for the target image, optionally with the metadata of the target image, are fed, optionally as a combination, into the combination component of the CSAM machine learning model.

At 320, a third outcome indicative of CSAM depicted in the target image is obtained as an outcome of the combination component.

When there are multiple segmentations of faces for a single target image the combination component generates the third outcome indicative of CSAM when at least one of the target faces is identified as under legal age.

At 322, one or more features described with reference to 302-320 are iterated. Iterations may be performed, for example, when the target image includes an animation created from multiple frames. Each frame may be processed as described with reference to 302-320. Alternatively, one or more sample frame are sampled from the multiple frames, for example, by selecting every nth frame, and/or when a significant change between frames is detected. Each sample frame represents a specific target image, for which features described with reference to 302-320 are iterated. CSAM may be identified for the animation when the third outcome indicative of CSAM is depicted in a number of sample frames above a threshold (e.g., number of frames per cluster and/or per sample that are classified as non-clean, i.e., any degree of CSAM). The threshold may be, for example, 1, to help ensure that CSAM is not missed.

At 324, a unique representation (e.g., hash) of the target image may be computed using the hashing process. The unique representation (e.g., hash) may be stored are a record in a hash dataset of hashes of previously evaluated images (sometimes referred to here as a customized dataset). The hash of the image may be associated with an indication of the third outcome, such as indicating that the target image depicts CSAM, or that the target image is clean. In some implementations, images which are identified as depicting CSAM are included in the hash dataset, while images that are identified as being clean are not included. In other implementations, both images identified as being clean and imaged identified as CSAM are included.

The unique identification (e.g., hash) of the image depicting CSAM enables quick evaluation of CSAM in newly accessed images (which are already known having previously been evaluated by the CSAM ML model) by searching the hash dataset to identify a match with the hash of the newly accessed image. Images that have already been evaluated and known to be clean may be quickly detected by the match of the hash when the dataset stores an indication of which images are clean.

At 326, frames that are statistically similar may be arranged into clusters.

Each cluster may be classified into a CSAM category on a CSAM scale of increasing CSAM severity, for example, according to a defined CSAM scale.

Clusters may increase accuracy of detecting CSAM and/or may increase speed of detected CSAM. For example, by considering the number of frames within the cluster that are classified as CSAM. If 1 frame is CSAM and 29 frames are non-CSAM, it may indicate that the CSAM detection is an error, for example, the face of the person was incorrectly identified as of a child when the person is an adult.

At 328, a data structure may be created for the target image. Optionally, a data structure is created per cluster.

The data structure may include one of more of: confidence of CSAM identification, start time of the animation when CSAM is identified, stop time of the animation when CSAM is identified, and most severe category of the CSAM scale detected.

The data structure may be implemented, for example, using JavaScript Object Notation (JSON).

At 330, one or more actions may be taken when CSAM is identified for the target image. For example:
For a target individual identified as being under the legal age, a segmentation of the target individual in the target image may be automatically blurred out. The face and/or body of the target individual may be blurred out. The blurring out may be performed before and/or while the image is being presented, so that the underage individual is not discernable.
Presentation of the target image on a display may be blocked. For example, an attempt at presentation of the image may trigger an error.
The target image may be deleted from a data storage device, for example, from a memory of a client terminal, from a hard drive, and/or from a remote server such as a server cloud and/or social network server.
When the target image is a frame in an animation for which the other frames are not identified as CSAM the frame identified as CSAM may be removed from the animation to create a non-CSAM animation.
A notification that CSAM is identified may be sent to a server, for example, to alert authorities (e.g., police) and/or a network administrator.

Referring now back to FIG. 4, flows 402A-C may be combined with, included in, and/or replaced with, features described with reference to FIGS. 2 and/or 3. Flows 402A-C may be implemented using components of system 100 described with reference to FIG. 1. Some features of the flow(s) are optional.

Flow 402A relates to extraction of metadata and/or sampling of frames. At 404, an image of multiple frames such as an animation is accessed. Optionally a link (e.g., URL) to the image is obtained. Parameters of the image may be obtained. Examples of parameters include: frame rate (i.e., how many frames in how many seconds (e.g., default may be 1 per second), flagged rate (i.e., how many frames of samples are classified as non-clean, default may be 1), metadata (e.g., yes/no, i.e., to extract and classify metadata), and available images formats. At 406, metadata of the image is extracted. At 408, a frame is sampled. Frames may be sampled as per the frame rate. Sampled frames may be extracted, for example, into JPEG or another image format. At 410, a quality test is performed to determine whether the sampled frame passes the quality test. For example, determine that the image is accessible and/or downloadable and/or available for viewing, determine that the image is formatted correctly and/or not corrupt. At 412, when the quality test is passed, the flow continues to 414 where a delta similarity is computed between frames (i.e., indicating amount of similarity between frames). At 416, when the delta similarity is below a threshold, the process continues to 418 where confirmed samples proceed to the next flow of 402B. Alternatively, at 414 when the delta similarity is not below (i.e., higher) than the threshold, the process returns to 408 to obtain another sample.

Flow 402B relates to checking whether the images has been previously found to be CSAM. At 420, confirmed samples (which passed flow 402A as described herein) are obtained. At 422, the sample frame is optionally hashed and compared to records of images (optionally records of hashes of images) of previously identified CSAM frames and/or non-CSAM frames stored in a global database. The global database may include frames and/or hashes of frames (e.g., when frames with CSAM cannot be stored) identified as CSAM using other approaches, for example, manually identified by the police, and/or by other automated approaches. It is noted that other representation than hash that uniquely identify the images may be used. At 424, the search is performed to find a match in the global database. At 426, a match in the global database is found. Alternatively, at 428, when no match is found in the global database, the (optionally, hash of the) sample frame is compared to records (optionally hashes) stored in a customized record (e.g., hash of images) database created by storing representation (e.g., hash) of frames previously identified as CSAM and/or previously identified as non-CSAM by at least some implementations described herein. At 430, the search is performed to find a match in the customized database. At 432, a match in the customized database is found. At 434, in respond to finding a match in the global database or in the customized database, the CSAM image may be reported, for example, to authorities and/or to a network administrator. Alternatively, at 436, the sample frame is determined to be unknown in terms of whether it depicts CSAM or not, and flow continues to 402C.

Flow 402C relates to determining whether unknown frames depict CSAM. At 440, confirmed samples (which passed flow 402A and/or 402B as described herein) are obtained. At 442, one or more faces are detected in the sample frame, and optionally segmented and/or extracted. At 444, each extracted face is analyzed to determine whether the segmented portion depicts a face. At 446, the sample image is rejected when no face is depicted, face(s) are occluded, face(s) are small (e.g., below a threshold), face(s) are blurred, face(s) are incomplete, and/or face(s) is of low quality. Reason for rejection may be noted. Rejected frames may be noted. Alternatively, at 448, a face is determined to be depicted. At 450, a quality evaluation is performed. When the quality evaluation fails, the process proceeds to 446 where the sample image is rejected. Alternatively, at 452, the quality evaluation passes. At 454, the face is analyzed to determine the age of the individual, for example, by the age ML model described herein. At 456, in parallel and/or sequentially (e.g., before and/or after 454) the image is analyzed to determine whether a depiction of sexuality is detected in the image, for example, by the sexuality ML model described herein. At 458, the indication of age is evaluated to determine whether the individual whose face is depicted in the sample image is under legal age. At 460, when the age of the individual is above the legal age, the sample is determined to be “clean”. At 462, the “clean” image may be hashed or another unique representation computed, and the hash and/or other unique representation added to the customized database, to enable quick determination of future instances of the same image as being “clean”. At 464, the indication of sexuality is evaluated to determine whether the sample image depicts non-clean sexuality, such as nudity and/or other sexual acts being performed. At 466, when no sexuality is determined for the sample image, the sample is determined to be “clean”, and the process may process to 462 to include a unique representation (e.g., hash) of the sample image in the customized database. Alternatively, when at 468 sexuality is determined for the sample individual, and at when at 470 the age of the individual whose face is depicted in the sample image is under legal age, at 472 CSAM is detected for the sample image.

Referring now back to FIG. 5, flows 502A-C may be combined with, included in, and/or replaced with, features described with reference to FIGS. 2 and/or 3. Flows 502A-C may be triggered in response to one of more of flows 402A-C described with respect to FIG. 4 where CSAM is detected. Flows 502A-C may be implemented using components of system 100 described with reference to FIG. 1. Some features of the flow(s) are optional.

Flow 502A relates to generating a summary of the detected CSAM. At 504, a summary classification of the collected data is generated, optionally a summary for each sample frame of the image (e.g., in the case of animation). At 506, a process summary is created. Alternatively or additionally, at 508, a cluster summary of images frames of each cluster is created. Clusters may be identified as frames that are statistically similar. At 510, an evaluation is performed to determine whether the image and/or cluster of frames passes one or more thresholds, for example, length of cluster, confidence in detection CSAM, start time, and end time. The thresholds may help distinguish between true CSAM and incorrectly identified CSAM (i.e., no CSAM actually present). At 512, when one or more thresholds are not passed, the CSAM designation may be labelled as unsubstantiated CSAM. CSAM may be unsubstantiated, for example, in a cluster for which only one frame is identified as CSAM, while other frames are not identified as CSAM. In such a case, the CSAM may be incorrect, for example, a face of an adult is incorrectly identified as a child in the one frame and correctly identified as an adult in the other frames. The unsubstantiated CSAM may be reported, for example, for manual evaluation by a user, to determine whether CSAM is depicted or not. Alternatively at 514, when the one or more thresholds are passed indicating confirmed CSAM, at 516, the CSAM may be reported and/or other actions may be triggers, for example, automatic blocking of the image and/or notification of authorities (e.g., police), as described herein.

Flow 502B relates to moderation and reporting. At 520, the unique representation (e.g., hash) of the image is matched to a record of a global database of known CSAM images (and/or known non-CSAM images), for example, as described with reference to flow 402B of FIG. 4. Alternatively or additionally, at 522, the unique representation (e.g., hash) of the image is matched to a record of a customized database of previously detected CSAM images (and/or previously cleared non-CSAM images), for example, as described with reference to flow 402B of FIG. 4. Alternatively or additionally, at 524, the summary results of an image for which CSAM has not yet been designated are obtained, for example, as described with reference to flow 502A. At 526, the results are processed. Optionally, at 528, the results are sent to a moderation API (or other interface) for further evaluation, for example, manual evaluation by a user. Results may be sent to moderation when results are not clearly CSAM, for example, CSAM is detected with a relatively low probability. At 530, the moderated results may be used to update the personalized database and/or CSAM ML model(s) (or components thereof) to indicate CSAM or non-CSAM, by continuing to feature 542. Alternatively or additionally, following 526, at 532, a data structure that includes the results for the image is created, optionally in JSON format. For CSAM clusters, the JSON data structure may store one or more of: threshold of length, confidence of the detected CSAM, start time in the image (i.e., animation), stop time, and highest classification of CSAM. CSAM clusters may be bundled into a single JSON data structure, which may be provided. GIF metadata may be bundled into a single JSON data structure, which may be provided. One or more actions may be triggered, for example, at 534 the JSON data structure which may indicate CSAM is reported to an external agency (e.g., police, network administrator), at 536 the result optionally in JSON format may be used to update the personalized database and/or CSAM ML model(s) (or components thereof) to indicate CSAM or non-CSAM, by continuing to feature 540, and at 538 the result optionally in JSON format may be reported to a client (e.g., user and/or automated process that requested an evaluation for presence of CSAM for a specific image).

Flow 502C relates to using the results of evaluating images for CSAM for update of databases and/or ML models. At 540, automatically created results, optionally in JSON format, are accessed. Alternatively or additionally, at 542, moderated results, optionally a manual evaluation for the presence of CSAM in an unsubstantiated image, are accessed. At 544, the customized database, of records of unique representations (e.g., hash) of images, is updated to indicate whether the record of the unique representation (e.g., hash) of the specific image, is identified as depicting CSAM or not. At 546, the CSAM ML model including one or more components thereof 552, is retrained and/or updated, such as for controlling bias, such input from 544 (i.e., the identified CSAM image(s) and/or identified non-CSAM images), from 548 using previously known CSAM image(s) and/or unknown CSAM image(s) from the global dataset, and/or from 550 using new annotated training datasets (e.g., as described herein). Manual reviews of CSAM classification by the CSAM ML model may be performed randomly and/or regularly to identify bias and/or specific false positive and/or false negative outcomes. ML models may be retrained when incorrect outcomes are found.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models will be developed and the scope of the term machine learning model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of training a machine learning model for detection of child sexual abusive materials (CSAM) depicted in a target image, comprising:
extracting segmentations of faces depicted in a plurality of first images of a plurality of first individuals in a plurality of first poses;
creating an age training dataset comprising a plurality of first records, wherein a first record includes an extracted segmented face and a ground truth label indicating whether the face is of an individual below a legal age;
training an age component on the age training dataset for generating a first outcome indicative of a target face segmented from the target image of a target individual being below the legal age;
creating a sexuality training dataset comprising a plurality of second records, wherein a second record includes a second image and ground truth label indicative of sexuality depicted in the second image;
training a sexuality component on the sexuality training dataset for generating a second outcome indicative of sexuality depicted in the target image;
defining a combination component that receives an input of a combination of the first outcome of the age component fed the target image and the second outcome of the sexuality component fed the target image, and generates a third outcome indicative of CSAM depicted in the target image; and
providing the machine learning model comprising the age component, the sexuality component, and the combination component.

2. The method of claim 1, wherein the age training dataset excludes images depicting CSAM.

3. The method of claim 1, wherein the sexuality training dataset excludes images depicting individuals below the legal age.

4. The method of claim 1, further comprising creating a combination training dataset comprising a plurality of third records, wherein a third record includes the first outcome of the age component fed a sample image and the second outcome of the sexuality component fed the sample image, and a ground truth label indicative of CSAM depicted in the sample image.

5. The method of claim 1, wherein the combination component comprises a set of rules that generates the third outcome indicating presence of CSAM in the target image when the first outcome of the age component indicates the target individual below the legal age and the second outcome of the sexuality component indicates sexuality depicted in the target image.

6. The method of claim 1, wherein the ground truth label indicative of sexuality depicted in the second image of the record of the sexuality training dataset indicates a clean image that excludes sexuality, or indicates a sexuality category selected from a plurality of sexuality categories indicative of increasing severity, wherein the second outcome comprises the indication of the clean image, or the sexuality category.

7. The method of claim 6, wherein the combination component generates the third outcome indicative of CSAM depicted in the target image when the first outcome indicates under legal age and the second outcome indicates any of the plurality of sexuality categories.

8. The method of claim 1, wherein the ground truth label indicating whether the face is of an individual below the legal age of the record of the age training dataset comprises at least one of: legal age, actual age, and an age category selected from a plurality of age categories under legal age, wherein the first outcome comprises the indication of the legal age, the actual age, or the age category under legal age.

9. The method of claim 8, wherein the combination component generates the third outcome indicative of CSAM depicted in the target image when the first outcome is an age under the legal limit or any of the age categories indicating under the legal limit.

10. A method of automated detection of CSAM depicted in a target image, comprising:
feeding a segmentation of a target face extracted from a target image, into an age component of a machine learning model, wherein the age component is trained on an age training dataset comprising a plurality of first records, wherein a first record includes a face extracted from an image of an individual in a certain pose and a ground truth label indicating whether the face is of an individual below a legal age;
obtaining from the age component, a first outcome indicative of a target individual associated with the target face being below the legal age;
feeding the target image into a sexuality component of a machine learning model, wherein the sexuality component is trained on a sexuality training dataset comprising a plurality of second records, wherein a second record includes a second image and ground truth label indicative of sexuality depicted in the second image;
obtaining from the sexuality component, a second outcome indicative of sexuality depicted in the target image;
feeding the first outcome and the second outcome into a combination component of the machine learning model; and
obtaining a third outcome indicative of CSAM depicted in the target image.

11. The method of claim 10, further comprising at least one of: (i) blurring a segmentation of the target individual in the target image, (ii) blocking presentation of the target image on a display, (iii) deleting the target image from a data storage device, (iv) when the target image is a frame in an animation for which the other frames are not identified as CSAM, removing the frame from the animation to create a non-CSAM animation, and (v) sending a notification to a server.

12. The method of claim 10, wherein the target image comprises an animation created from a plurality of frames, further comprising sampling at least one sample frame from the plurality of frames as at least one specific target image, wherein the features of the method are iterated for each specific target image, wherein CSAM is identified for the animation when the third outcome indicative of CSAM is depicted in a number of sample frames is above a threshold.

13. The method of claim 12, further comprising:
identifying a plurality of clusters of frames for which CSAM is identified;
classifying each cluster into a category of a CSAM scale of increasing CSAM severity.

14. The method of claim 13, further comprising:
for each cluster, creating a data structure that includes at least one of: confidence of CSAM identification, start time of the animation when CSAM is identified, stop time of the animation when CSAM is identified, and most severe category of the CSAM scale detected.

15. The method of claim 10, further comprising:
in response to the third outcome being indicative of CSAM, computing a hash of the target image and storing the hash in a hash dataset;
wherein in response to a new image, computing the hash of the new image, and searching the hash dataset to identify a match with the hash of the new image.

16. The method of claim 10, further comprising segmenting each of a plurality of target faces depicted in the target image, and feeding each of the plurality of target faces into the age component to obtain a plurality of first outcomes, wherein the combination component generates the third outcome indicative of CSAM when at least one of the plurality of target faces is identified as under legal age.

17. A system for automated detection of CSAM depicted in a target image, comprising:
at least one hardware processor executing a code for:
feeding a segmentation of a target face extracted from a target image, into an age component of a machine learning model, wherein the age component is trained on an age training dataset comprising a plurality of first records, wherein a first record includes a face extracted from an image of an individual in a certain pose and a ground truth label indicating whether the face is of an individual below a legal age;
obtaining from the age component, a first outcome indicative of a target individual associated with the target face being below the legal age;
feeding the target image into a sexuality component of a machine learning model, wherein the sexuality component is trained on a sexuality training dataset comprising a plurality of second records, wherein a second record includes a second image and ground truth label indicative of sexuality depicted in the second image;
obtaining from the sexuality component, a second outcome indicative of sexuality depicted in the target image;
feeding the first outcome and the second outcome into a combination component of the machine learning model; and
obtaining a third outcome indicative of CSAM depicted in the target image.

18. The system of claim 17, further comprising code for training the machine learning model for detection of child sexual abusive materials (CSAM) depicted in a target image, comprising:
extracting segmentations of faces depicted in a plurality of first images of a plurality of first individuals in a plurality of first poses;
creating the age training dataset comprising a plurality of first records, wherein a first record includes an extracted segmented face and a ground truth label indicating whether the face is of an individual below a legal age;
training the age component on the age training dataset for generating a first outcome indicative of a target face segmented from the target image of a target individual being below the legal age;
creating the sexuality training dataset comprising a plurality of second records, wherein a second record includes a second image and ground truth label indicative of sexuality depicted in the second image;
training the sexuality component on the sexuality training dataset for generating a second outcome indicative of sexuality depicted in the target image;
defining the combination component that receives an input of a combination of the first outcome of the age component fed the target image and the second outcome of the sexuality component fed the target image, and generates a third outcome indicative of CSAM depicted in the target image; and
providing the machine learning model comprising the age component, the sexuality component, and the combination component.
